(19) United States
(12) Patent Application Publication
(10) Pub. No.: US 2003/0182536 A1
(43) Pub. Date: Sep. 25, 2003

(54) Instruction issuing device and instruction issuing method

(76) Inventor: Tatsuo Teruyama, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/134,373

(22) Filed: Apr. 30, 2002

(30) Foreign Application Priority Data
Mar. 19, 2002 (JP) 2002-077091

(51) Int. Cl. G06F 9/30

(52) U.S. Cl. 712/214; 712/225

(57) ABSTRACT

A first detecting circuit detects a register depending directly on a load instruction. A second detecting circuit detects indirect dependencies of plural stages between all instructions in a state of execution and all load instructions of the respective stages of a pipeline, in accordance with cache miss signals and output signals of the first detecting circuit.

### CROSS-REFERENCE TO RELATED APPLICATIONS

This application is based upon and claims the benefit of priority from the prior Japanese Patent Application No. 2002-077091, filed Mar. 19, 2002, the entire contents of which are incorporated herein by reference.

### BACKGROUND OF THE INVENTION

1. Field of the Invention

The present invention relates to, for example, a microprocessor for issuing instructions out-of-order, and in particular, to an instruction issuing device and an instruction issuing method to be used in an instruction schedule unit.

2. Description of the Related Art

Out-of-order execution is a method of executing an instruction in a microprocessor. Out-of-order execution is a method of randomly executing instructions without depending on preceding instructions. Out-of-order execution can enable effective utilization of a computer, and a microprocessor to operate at high speed.

A microprocessor for issuing instructions out-of-order issues and executes instructions speculatively. Thus, when a cache miss arises in a load instruction, several instructions whose data depends on this load instruction must be rendered invalid. Thereafter, when the cache memory is refilled, the instruction group depending on the load instruction which had the cache miss is reissued and executed.

FIG. 14 shows the dependency of a load instruction and a plurality of instructions issued following the load instruction. Here, I, R, E, and M represent respective stages of a pipeline. I is instruction fetching, R is register renaming, E is execution, and M is data cache access. The latency from issuance of the load instruction until the instruction reads the operand is three cycles. Thus, at the cycle after the load instruction is issued, and the cycle thereafter (slots 1, 2 shown in FIG. 14), scheduling is carried out such that the load instruction and instructions on which data depends cannot be issued. In slot 3 and slot 4, it is assumed that the cache has hit, and an instruction depending on the load instruction is issued speculatively. At the M stage, the cache miss becomes clear. Thus, due to the delay caused by scheduling of instructions, at the point of instruction issuance of slot 4, the presence/absence of a cache miss of slot 0 cannot be considered.

Because the load instruction of slot 0 has a cache miss, data cannot be obtained. Thus, although the instructions of slot 3 and slot 4 are issued, they cannot be executed correctly. Accordingly, the load instruction of slot 0 at which there is a cache miss, and the instructions at slots 3, 4 are all cancelled. Thereafter, refilling of the cache is carried out, and the load instruction is reissued. Moreover, the cancelled instructions at slots 3, 4 are reissued. There are also cases in which instructions where data does not depend on the load instruction are disposed at slots 3 and 4. In this case, there is no need to cancel the instructions. However, it is difficult to determine whether or not to cancel the instructions in accordance with the presence/absence of dependency. Thus, the instructions of slots 3, 4 are cancelled for the time being, and are reissued later. Accordingly, instructions are cancelled needlessly, and the instruction execution efficiency deteriorates.

Each slot can execute a plurality of instructions. Recently, a microprocessor has been developed which, at one slot, can simultaneously execute two integer operation instructions. In this case, a total of four instructions are cancelled. When none of the four instructions is dependent on the load instruction, all are cancelled needlessly.

For example, the document “R. E. Kessler, ‘The Alpha 21264 Microprocessor Architecture’, Proceedings International Conference on Computer Design: VLSI in Computers and processors, 1998, ICCD '98, pp. 90-95” discloses a method for reissuing an instruction group depending on a load instruction having a cache miss.

In the aforementioned document, it is predicted whether or not the load instruction has hit. Only when it is predicted that the load instruction has hit, the dependent instruction is executed. The probability of canceling an instruction is thereby lowered. However, even when it is predicted that the load instruction has hit and an instruction not dependent on the load instruction is issued, there are cases where the load instruction has actually not hit. In this case, the instruction not dependent on the load instruction is needlessly cancelled.

In order to not needlessly cancel the nondependent instructions, it is determined whether or not the instructions of slots 3, 4 are dependent on the load instruction, and only dependent instructions are cancelled. However, in actuality, it is insufficient to determine only whether or not the instructions after the load instruction are dependent on the results of the load instruction. Namely, even if it does not depend directly on the load instruction, there is the need to investigate whether or not, for example, the instruction of slot 4 depends on the instruction of slot 3 which depends directly on the load instruction. Namely, there is the need to cancel not only instructions directly depending on the load instruction, but also instructions depending on instructions depending directly from the load instruction, i.e., instructions having indirect dependencies of plural stages.

However, generally, all of the dependent instructions issued speculatively are cancelled without detecting indirectly dependent instructions. In this case, instructions which do not have to be cancelled are cancelled, and the execution efficiency deteriorates. Further, in order to detect all of the indirect dependencies of plural stages, a data flow graph must be traced. When attempts are made to realize this, the hardware costs become large, and there is a cause of lowering of the efficiency. Thus, an instruction issuing device and an instruction issuing method which, when a cache miss is generated in a load instruction, can detect at high speed instructions having dependencies of plural stages on the load instruction, have been desired.

### BRIEF SUMMARY OF THE INVENTION

According to an aspect of the invention, there is provided an instruction issuing device comprising: an instruction issuing section which speculatively issues instructions out-of-order; a first detecting circuit which detects direct dependencies between the instructions issued from the instruction issuing section and a plurality of instructions including a load instruction in each stage of a pipeline; and a second detecting circuit to which output signals of the first detecting circuit and cache miss signals of the load instruction are supplied, the second detecting circuit detecting indirect dependencies between the instructions issued from the instruction issuing section and the load instruction which cache-missed in each stage of the pipeline, on the basis of the output signals of the first detecting circuit and the cache miss signals of the load instruction.

According to another aspect of the invention, there is provided an instruction issuing method comprising: detecting direct dependencies of a load instruction and following instructions in a first detecting circuit; detecting indirect dependencies of the load instruction and following instructions in a second detecting circuit, and converting the detected indirect dependencies to direct dependencies; and detecting instructions having indirect dependencies on the load instruction by a signal showing that a cache miss has arisen in the load instruction and the converted direct dependencies.

### BRIEF DESCRIPTION OF THE SEVERAL VIEWS OF THE DRAWING

FIG. 1 is a structural diagram showing an embodiment of an instruction issuing device of the present invention.

FIG. 2 is a diagram showing an example of a pipeline of the present embodiment.

FIG. 3 is a structural diagram showing an example of an instruction window buffer.

FIG. 4 is a structural diagram showing an example of respective entries forming the instruction window buffer.

FIG. 5 is a structural diagram showing an example of an update circuit of the instruction window buffer.

FIG. 6 is a structural diagram showing an example of a dispatch decision circuit.

FIG. 7 is a structural diagram showing an example of a circuit deciding an issue scheduling entry.

FIG. 8 is a structural diagram showing an example of an instruction window buffer.

FIG. 9 is a diagram showing an example of operation timing of an ALU instruction.

FIG. 10 is a diagram showing an example of operation timing of a load instruction.

FIGS. 11A, 11B, and 11C are pipeline diagrams and data flow graphs respectively showing examples of the dependencies of a load instruction and other instructions.

FIG. 12 is a circuit diagram showing one embodiment of a DLC (dependency lashing circuit).

FIG. 13 is a circuit diagram showing an example of an update circuit of a RAT.

FIG. 14 is a diagram showing the dependencies of a load instruction and a plurality of instructions issued following the load instruction.

### DETAILED DESCRIPTION OF THE INVENTION

Hereinafter, embodiments of the present invention will be described with reference to the figures.

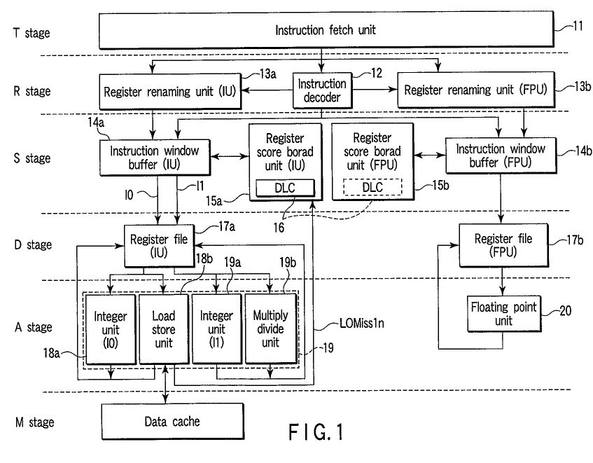

FIG. 1 shows a structure of an instruction issuing device and an executing unit. Firstly, the structure of FIG. 1 will be described summarily.

The instruction issuing device has, for example, T stage, R stage, S stage, D stage, and A stage. The respective stages of the R stage and stages thereafter have dual circuits formed from an integer unit (IU) and a floating point unit (FPU).

The T stage is an instruction fetching stage and has an instruction fetch unit 11 for fetching an instruction. The instruction fetch unit 11 fetches, for example, two instructions simultaneously.

The R stage is a register renaming stage. The R stage has an instruction decoder 12 and register renaming units 13a, 13b connected to the instruction fetch unit 11. The register renaming units 13a, 13b are further connected to the instruction decoder 12. The instruction decoder 12 decodes an instruction supplied from the instruction fetch unit 11. The respective register renaming units 13a, 13b assign unused physical registers respectively to, for example, the logic registers of the two decoded instructions.

The S stage is an instruction scheduling stage. The S stage has instruction window buffers (instruction issuing sections) 14a, 14b, and register score board units 15a, 15b. The instruction window buffer 14a is connected to the instruction decoder 12, the register renaming unit 13a, and the register score board unit 15a. Further, the instruction window buffer 14b is connected to the instruction decoder 12, the register renaming unit 13b, and the register score board unit 15b.

The register score board units 15a, 15b are structured from, for example, flip-flop circuits, and hold information (flags) showing whether or not there is data valid for a writing register of an instruction being executed in a pipeline. The instruction window buffers 14a, 14b hold physical register numbers after register renaming and the like, and issue instructions, when a predetermined condition is satisfied, on the basis of instruction statuses from the register score board units 15a, 15b. The instruction window buffer 14a issues an instruction to pipelines I0, I1.

The register score board unit 15a is connected to a dependency lashing circuit (DLC) 16. The DLC 16 retrieves an instruction depending directly or indirectly on a load instruction. The DLC 16 is provided for the register score board unit 15a. This is because the load instruction, generally, directly writes data into a register file. However, in accordance with an instruction set, there are cases in which the instruction set writes data as a floating point register file. Accordingly, as shown by a broken line in FIG. 1, the DLC 16 may be provided at the score board unit 15b.

Details of the instruction window buffer 14a, the register score board unit 15a, and the DLC 16 will be described later.

The D stage is a register reading stage. The D stage has register files 17a, 17b. The register file 17a is connected to the aforementioned instruction window buffer 14a, and the register file 17b is connected to the instruction window buffer 14b.

The A stage is an ALU operation stage. The A stage has operation units 18, 19, and a floating point unit 20. The operation unit 18 has an integer unit 18a and a load store unit 18b. The operation unit 19 has an integer unit 19a and a multiply/divide unit 19b. The integer unit 18a, the load store unit 18b, the integer unit 19a, and the multiply/divide unit 19b are connected to the register file 17a. The floating point unit 20 is connected to the register file 17b.

The load store unit 18b maintains data dependency via a memory for a load instruction and a store instruction processed out-of-order in a processor carrying out out-of-order execution. Concretely, the load store unit 18b grasps the order of the memory access instructions, and manages the order of the memory access instructions issued out-of-order. Further, when a data cache miss-hits in the execution of a load instruction, the load store unit 18b outputs a cache miss signal LOMiss1n (n is the stage of the pipeline). The cache miss signal LOMiss1n is supplied to the DLC 16.

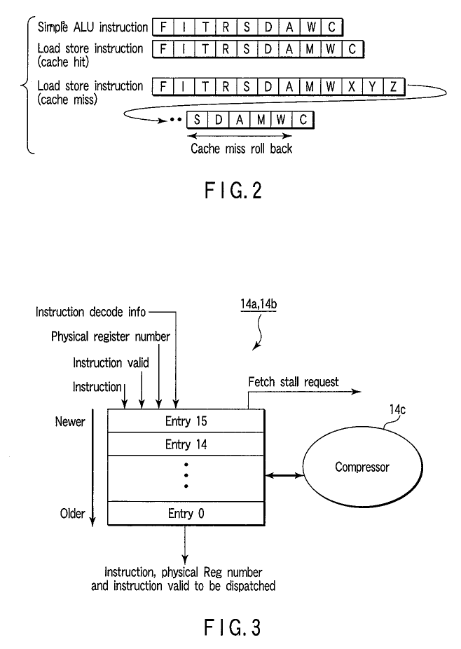

FIG. 2 is a diagram showing an example of a pipeline of the present embodiment. The meanings of the respective stages are as follows.

F: Instruction fetch stage 1

I: Instruction fetch stage 2

T: Transfer instruction

R: Register renaming

S: Instruction scheduling

D: Register read

A: ALU operation

W: Write back

X: Next to write back

Y: 2nd next to write back

Z: 3rd next to write back

C: Complete

M: Data cache access

In the structure shown in FIG. 1, the T stage corresponds to the F, I, and T stages in FIG. 2.

Next, operations of the respective sections shown in FIG. 1 will be described.

(Instruction Fetching)

The instruction fetch unit 11 fetches two instructions which have to be executed. The two instructions fetched by the instruction fetch unit 11 are supplied to the R stage.

(Register Renaming)

The instruction decoder 12 decodes the instructions supplied from the instruction fetch unit 11, and determines whether the instruction needs a source operand or the operation results are to be written into a destination register. The register renaming units 13a, 13b assign physical register numbers to the logic register numbers of a source register and a destination register of the instructions on the basis of the instructions and the decoded information. The physical register numbers, assigned to the logic register numbers until that time, are stored in correspondence in a mapping table (not shown). Therefore, the physical register number assigned last can be retrieved by using the logic register number as a key. When the source register is assigned, logic register numbers (Rs, Rt) fetched from the instruction code are inputted to the mapping table as indices, and physical register numbers (PRs, PRt) are retrieved. When the destination register (Rd) is assigned, firstly, an unused physical register number is fetched from a free list holding unused physical register numbers. This physical register number is assigned to the destination register. Further, the assigned physical register number (PRd) is written in the mapping table so as to be able to be referred to by using the logic register number as a key. The physical register numbers (the physical registers numbers overwritten in the mapping table) which have been assigned to the same logic register number until that time are, together with the logic register number, written into an active list. The active list can queue a maximum of 64 instructions. Index numbers are given to the respective entries in the active list. The index numbers are used to identify an instruction as ITag in other units.

(Instruction Window Buffer)

FIG. 3 shows an example of the instruction window buffers 14a, 14b. The instruction window buffers 14a, 14b have, for example, 16 entries. The respective entries are arranged in order from the oldest instruction. When a new instruction is supplied from the instruction fetch unit 11, the new instruction is written into an entry near the entry containing the oldest instruction among empty entries.

The instruction window buffers 14a, 14b store instruction decode information supplied from the instruction decoder 12, a physical register number supplied from the register renaming units 13a, 13b, an instruction code supplied from the instruction fetch unit 11, and an instruction valid (Valid) signal. Namely, when the instruction valid signal outputted from the instruction fetch unit 11 is “1”, the instruction window buffers 14a, 14b write the instruction code and the physical register number and the like into an empty entry. When there become no empty entries in the instruction window buffer, a fetch stall request is asserted for the instruction fetch unit 11.

The instruction window buffers 14a, 14b have a compressor 14c. After an instruction is issued to the execution unit, the compressor 14c invalidates the entry of the issued instruction, and prepares an empty entry.

As described above, the respective stages of the R stage and stages thereafter have dual circuits formed from an integer unit (IU) and a floating point unit (FPU). However, in the following description, the operation of the FPU will be omitted, and only the operation of the IU will be described.

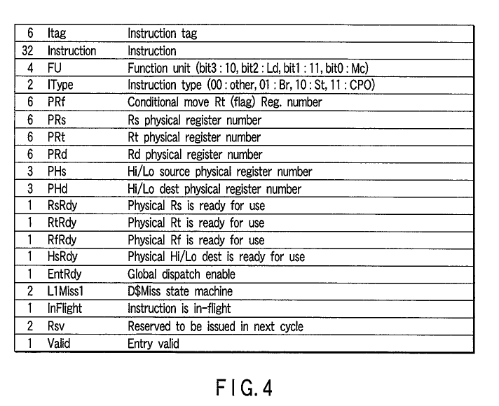

FIG. 4 shows formats of the respective entries structuring the instruction window buffer. The respective fields shown in FIG. 4 will be simply described.

ITag: An identifier uniquely given to an instruction, and having any value of 0 to 63. This value is equal to an entry number in the active list.

Instruction: Instruction code itself having a 32 bit length.

FU: A field showing a functional unit which has to issue an instruction. An instruction is decoded in the R stage, and the FU (functional unit) is decided in accordance with the type of the instruction. The FU is, together with the register renaming information, written in the instruction window buffer. The FU is structured by 4 bits. Bit 3 shows that the instruction is an ALU instruction and has to be issued to the IO integer unit. Bit 2 is a load store unit. Bit 1 shows that the instruction has to be issued to the I1 integer unit, and bit 0 shows that the instruction has to be issued to the multiply/divide unit.

PRs, PRt, PRf: Physical register numbers of the source operand.

PRd: Physical register number of the destination.

RsRdy, RtRdy, RfRdy: Flags showing that PRs, PRt, PRf of the source register can be used. Namely, RsRdy, RtRdy, and RfRdy are set three cycles before the state in which execution of the instruction for writing into the physical registers of the same numbers as Rs, Rt, Rf is completed and the operation results can be used (through the internal bypass or the register file). These three cycles correspond to the latency from referring to the Rdy bit to the instruction being issued and the instruction reading the operand.

EntryRdy: Global entry ready bit set by some reason, for example, when an instruction is executed in-order. Further, cleared in a case of execution-impossible at a given time.

L1MissSM: Register holding a state such as cache miss, non-cache access, or the like, in the case of a load instruction or a store instruction. For deciding the reissue (rollback) timing after cache miss of an instruction.

InFlight: Showing that instruction of the entry is currently being executed.

Rsv: Showing to which unit (I0/I1) an entry is scheduled to be issued at the next cycle.

Valid: Showing whether there is a valid entry or not.

(Updating Instruction Window Buffer Entry)

The instruction window buffer 14a has an update circuit for updating the respective entries.

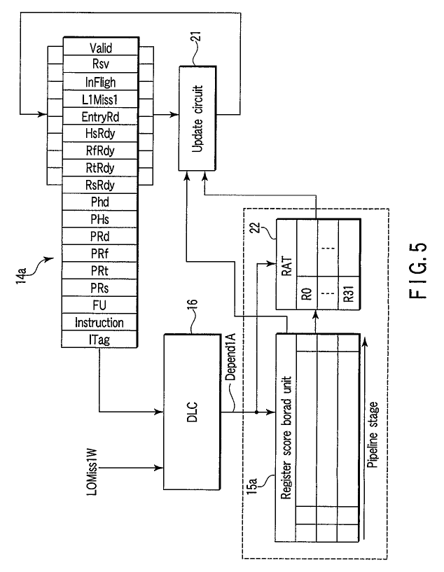

FIG. 5 shows an example of an update circuit 21 of the instruction window buffer 14a. In FIG. 5, the same reference numerals are given to the same portions as in FIG. 1.

The update circuit 21 is connected to each entry in the instruction window buffer 14a. The update circuit 21 updates various types of status bits of the instructions stored in the instruction window buffer 14a in accordance with the executing status of the preceding instruction. Namely, a RAT (Register Availability Table) 22 is connected to the update circuit 21. The register score board unit 15a is connected to the RAT 22. The register score board unit 15a and the RAT 22 are storing sections referring to a physical register number as a key, and show whether the physical register can be used or not. The RAT 22 sets a flag to the physical register storing the operation results, in accordance with a signal supplied from the register score board unit 15a and the DLC 16 after completing the operation of the data. The update circuit 21 updates an entry at each cycle on the basis of the status of the register supplied from the RAT 22 and the status of the instruction supplied from the register score board unit 15a.

Moreover, the DLC 16 is connected to each entry of the instruction window buffer 14a. The DLC 16 retrieves an instruction depending on the load instruction in accordance with a cache miss signal outputted from the load store unit 18b. A signal Depend1A showing dependency and outputted from the DLC 16 is supplied to the register score board unit 15a and the RAT 22. When the signal Depend1A is outputted from the DLC 16, the entry of the RAT 22 for the dependent physical register is invalidated on the basis of the status of the instruction of the register score board unit 15a. Moreover, the update circuit 21 resets the dependent physical register in an invalid state in the instruction window buffer 14a. The detailed operation when a cache miss arises at the time of executing the load instruction will be described later.

(Instruction Issuing)

As described above, the instruction issuing device of the present embodiment issues two instructions simultaneously. The instructions of the respective entries of the instruction window buffer 14a are set in a state of being able to be issued when the following conditions are satisfied.

(1) All RsRdy, RtRdy, RfRdy, HsRdy, and EntryRdy are set (in a state of allowing issuance).

(2) Instruction execution units (IU0, IU1, LSU, MAC) designated by the FU complete the former operation, and are in a state of being able to receive an instruction.

(3) There is no write port conflict of the register file (at the time when the results should be written in the register file, the write port is empty).

(4) InFlight bit is cleared (the same instruction is not currently being executed).

(5) L1MissSM is not in an issuing stall state.

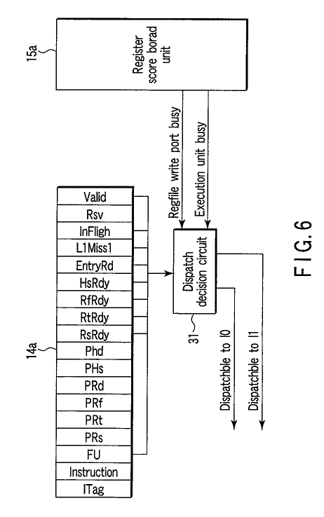

FIG. 6 shows an example of a dispatch decision circuit 31 for determining the above-described conditions. The dispatch decision circuit 31 is independently provided for the respective entries of the instruction window buffer 14a. FIG. 6 shows the dispatch logic of one entry. The dispatch decision circuit 31 is connected to the respective entries of the instruction window buffer 14a and the register score board unit 15a. The dispatch decision circuit 31 determines the above-described conditions in accordance with signals supplied from the respective entries of the instruction window buffer 14a and the register score board unit 15a. In accordance with this determination, the dispatch decision circuit 31 outputs signals dispatchable to I0, I1 showing that the respective entries can issue an instruction to each execution unit respectively.

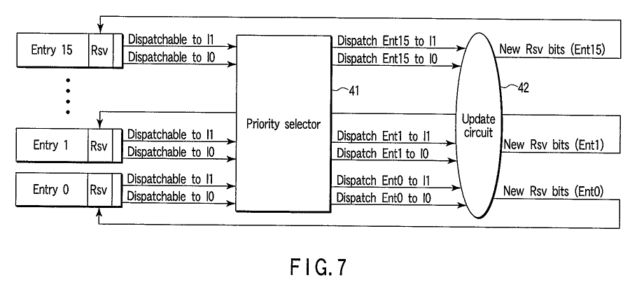

FIG. 7 shows an example of a circuit for deciding an issue schedule entry from the issuable entries. The signals dispatchable to I0, I1 outputted from the dispatch decision circuit of each entry are supplied to the input end of a priority selector 41. The output end of the priority selector 41 is supplied to an update circuit 42.

When a plurality of entries can be issued simultaneously for the same execution unit, the priority selector 41 selects the signals dispatchable to I0, I1 outputted from the oldest entry thereamong. Further, the priority selector 41 outputs a signal dispatch EntX to IY (X=0, 1 to 15), (Y=0, 1) to the selected entry. This signal dispatch EntX to IY (X=0, 1 to 15), (Y=0, 1) is supplied to the update circuit 42. The update circuit 42 sets an Rsv bit corresponding to the entry to which the signal dispatch EntX to IY (X=0, 1 to 15), (Y=0, 1) asserted.

(Regarding 16-1Mux Control)

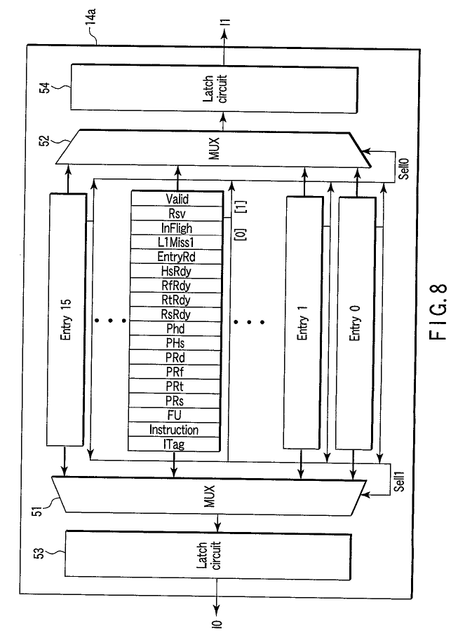

FIG. 8 is a structural diagram showing an example of the instruction window buffer 14a. FIG. 8 shows a state in which instructions are issued to the pipeline I0 and the pipeline I1 from 16 entries. Input ends of multiplexers (MUX) 51, 52 are connected to the respective entries 0 to 15. The multiplexers 51, 52 are controlled in accordance with the contents of the Rsv bit of each entry. An output end of the multiplexer 51 is connected to a latch circuit 53, and an output end of the multiplexer 52 is connected to a latch circuit 54. The latch circuit 53 issues an instruction to the pipeline I0, and the latch circuit 54 issues an instruction to the pipeline II.

As described above, when an Rsv bit expressing an instruction issue schedule provided at each entry of the instruction window buffer 14a is set, the entry is an instruction dispatched in the next cycle. Thus, when Rsv[1] is set, it proceeds to the pipe I0 via the multiplexer 52, and when Rsv[0] is set, it proceeds to the pipe I1 via the multiplexer 51. Namely, at the end of S stage (the cycle where the Rsv bit is already set), in accordance with the value of the Rsv bit, one entry is selected from among the 16 entries, for each of the pipes I0 and I1 by the multiplexers 51, 52. The selected entries are latched by the latch circuits 53, 54. The output signals of the latch circuits 53, 54 are sent to the respective operation units via the register file 17a. The output signal of the latch circuit 53 is supplied to the integer unit 18a provided at the pipeline I0, and to the load store unit 18b. The output signal of the latch circuit 54 is supplied to the integer unit 19a provided at the pipeline I1, and to the multiply/divide unit 19b. Each operation unit reads out data from the register file 17a, and carries out a determined operation or memory access. The results of operation of each operation unit are written into the register file 17a.

(Referencing and Updating of RAT)

As described above, the RAT 22 shown in FIG. 5 is a table for reference using a physical register number as a key, and shows whether or not the physical register can be used. This RAT 22 is a portion of a register score board logic. When, for example, “1” is set as the entry of the RAT 22, it shows that the data of the physical register corresponding to this entry is already determined and can be referenced. Further, when, for example, “0” is set as the entry of the RAT 22, the data of the physical register corresponding to this entry cannot be referenced.

The update circuit 21 refers to the RAT 22 corresponding to Rs, Rt, and Rf of the respective entries of the instruction window buffer 14a. As a result, RsRdy, RtRdy, and RfRdy are set when “1” is set as the entries corresponding to Rs, Rt, and Rf of the RAT 22. Further, the update circuit 21 refers to the RAT 22 corresponding to Rs, Rt, and Rf of the respective entries of the instruction window buffer 14a. As a result, RsRdy, RtRdy, and RfRdy are cleared when “0” is set as the entries corresponding to Rs, Rt, and Rf of the RAT 22.

In order to check the dependency of the data, there is a lag between the time for referencing the RAT 22 at the time of instruction dispatch, and the time for referencing the data in actuality (reading the register file 17a, or bypassing the data). Thus, when execution of a given instruction is completed, at a time three cycles earlier than the writing of data into the physical destination register, the RAT 22 of that write register is set.

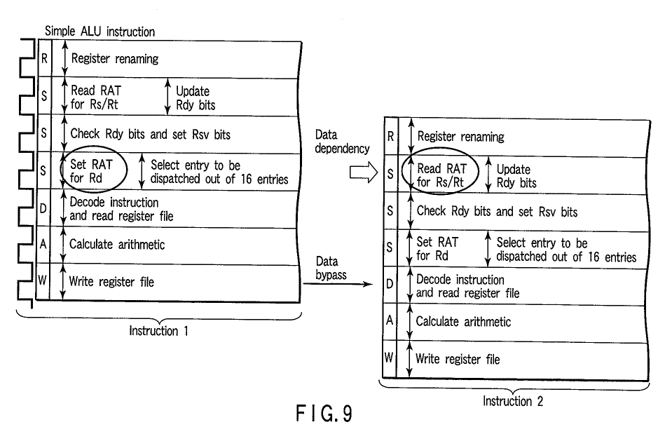

FIG. 9 shows an example of the operation timing of an ALU instruction. In FIG. 9, the RAT 22 is set at the S stage. On the other hand, the data is actually obtained at the W stage three cycles after. Thus, there is a lag between the set time of the RAT 22 and the writing time.

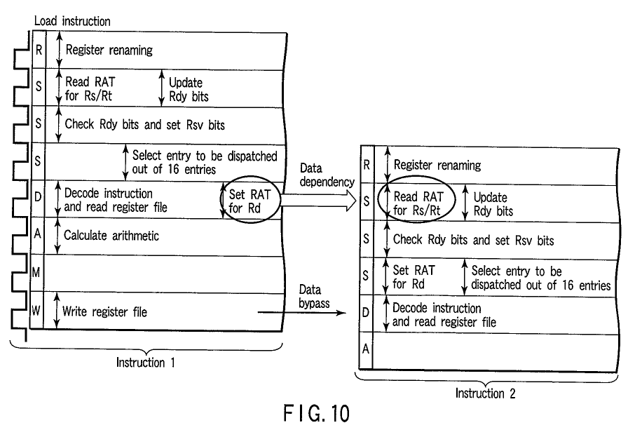

FIG. 10 shows an example of the operation timing of a load instruction. In the case of a load instruction, the RAT 22 is set at the D stage three cycles before the W stage.

Further, when this physical register can no longer be used, the RAT 22 corresponding to this physical register is cleared. Namely, another physical register is assigned to the same logic register, and when use thereof is finished, the physical register assigned previously is released. At this time, the RAT 22 corresponding to this physical register is cleared.

Moreover, usually, the RAT 22 is immediately updated, even for a destination register of an instruction executed speculatively. This is because a dependent instruction is executed at the shortest latency, and the merits of out-of-order are utilized. However, when a branch prediction miss or an exception arises, the RAT 22 must be returned at the time of in-order which is when the branch instruction, for which there was a prediction miss, or the instruction, at which an exception occurred, is completed. For example, an instruction after an instruction at which an exception arises must be stopped before execution. Thus, the physical register which this instruction writes must be made invalid within the RAT. For convenience, such a RAT is called a working RAT.

However, in actuality, instructions are executed speculatively. Thus, there is the possibility that the working RAT is already set. Accordingly, when execution of an instruction is completed, generation of an exception or a branch prediction miss is determined, and one set of a RAT updating in-order and having a state at the time of completion of execution (called an in-order RAT for convenience) is provided separately. At the time of occurrence of an exception or a branch prediction miss, the contents of the in-order RAT are batch copied to the working RAT. In this way, the working RAT can be restored to the state immediately after the branch prediction miss or the occurrence of the exception.

(Operation at Time of a Data Cache Miss)

As can be seen from the timing diagram of the load instruction shown in FIG. 10, setting of a RAT corresponding to the destination register Rd of the load instruction is carried out at the D stage of the load instruction in order to make the latency be the shortest. This is three cycles before the W stage at which the cache miss becomes clear. Namely, even though there is a state in which the load instruction may miss during these three cycles, an instruction whose data depends on the result of execution of the load instruction is issued. By making the structure in this way, if the load instruction hits, the instruction can be executed at the minimum latency.

Essentially, three cycles, which are a cycle for updating the RAT, a cycle for referring, and a cycle for dispatching, correspond to the three cycles. However, this cannot be zero cycles. Therefore, a period until speculative execution exists certainly by the amount of these cycles.

When a cache hits, no problems arise. Accordingly, the execution of the instruction should be continued. However, when a cache miss arises, the following processings must be carried out. Namely,

(1) The load instruction in which a cache is missed, and an instruction depending on the load instruction and in which the schedule is completed or which is in the midst of execution are invalidated.

(2) The destination register of the load instruction in the RAT, and the destination register of an instruction depending on the load instruction are cleared.

(3) An invalidated instruction is executed again after the cache is refilled.

In order to carry out the above-described processings, firstly, instructions depending on the load instruction and in the midst of execution, and instructions unrelated to the load instruction have to be distinguished. Further, as described above, the load instruction has a speculative execution period of three cycles. Therefore, there is the need to detect not only instructions depending on the load instruction directly, but also instructions with indirect dependency, which are the second instruction depending on the first instruction depending on the load instruction, and further, the third instruction depending on the second instruction. Further, dependencies which are parallel at a plurality of load instructions have to detected such as the source register Rs of a given instruction depends on the first load instruction and the source register Rt depends on the second load instruction. Moreover, dependencies in which these are combined must be detected.

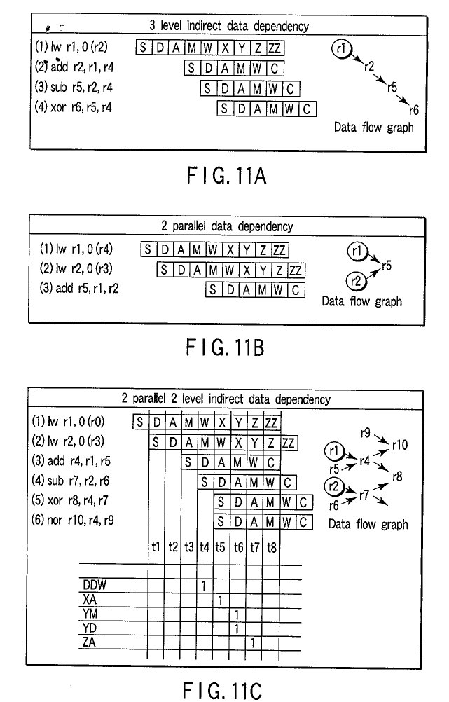

FIG. 11A, FIG. 11B, FIG. 11C show pipeline diagrams showing examples of the dependency of the above-described load instruction and other instructions, and data flow graphs. All of the examples shown in FIGS. 11A to 11C are cases in which an instruction be issued before a cache miss becomes clear. In these cases, the register number denotes not a logic register but a physical register.

An example of a case of a 2-parallel 2-level indirect dependency shown in FIG. 11C will be described. The registers shown by the ◯ mark in the data flow graph are the results of the load instruction before a cache miss is determined. Noticing the load instruction, r4 depends on r1, and r7 depends on r2. Moreover, r8 depends on r4 and r7, and r10 depends on r4.

In FIG. 11C, when lw (load) instruction of (1) cache-misses and lw (load) instruction of (2) cache-hits, processing is carried out as follows.

Firstly, all of the data depending on r1 corresponding to the load instruction of (1) is invalidated. However, the data depending on r2 corresponding to the load instruction of (2) is valid. Therefore, r4, r10 and r8 of the RAT are invalidated. Moreover, the instructions of (3), (5) and (6) using these r4, r10 and r8 are invalidated, and reissued. However, r7 of the RAT and the sub-instruction of (4) are not invalidated.

In order to execute the above-described series of operations, the following processings are carried out.

(1) Detecting of indirect dependency by the dependency lashing circuit (DLC) 16.

(2) Updating of the RAT.

(3) Rollback operation at the instruction window buffer.

(Detecting of Indirect Dependency by the DLC)

Firstly, detecting of the load instruction and an instruction depending on the load instruction by the DLC 16 will be described.

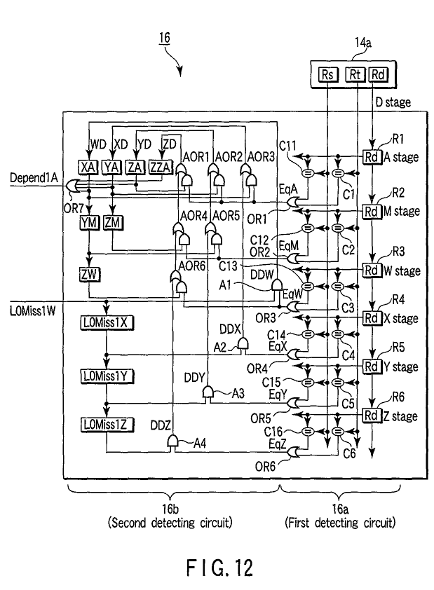

FIG. 12 shows an embodiment of the DLC 16. In FIG. 12, a first detecting circuit 16a detects a register depending on the load instruction directly. Further, a second detecting circuit 16b detects indirect dependencies of plural stages.

The first detecting circuit 16a has registers R1 to R6, comparators C1 to C6 and C11 to C16, and OR circuits OR1 to OR6, of the same number as the number of pipeline stages. The registers R1 to R6 are connected in series, and form a so-called shift register. These registers R1 to R6 hold the numbers of the destination registers (Rd) successively outputted from the instruction window buffer 14a of the D stage in correspondence with the execution of instructions. The numbers of the source registers (Rt) successively outputted from the instruction window buffer 14a are supplied to one input ends of the comparators C1 to C6. Output signals of the aforementioned registers R1 to R6 are supplied to the other input ends of these comparators C1 to C6 respectively. Further, the numbers of the source registers (Rs) successively outputted from the instruction window buffer 14a are supplied to one input of the aforementioned comparators C11 to C16. Output signals of the aforementioned registers R1 to R6 are supplied to the other inputs of these comparators C11 to C16 respectively. The outputs of the aforementioned comparators C1 to C6 are supplied to one input of the OR circuits OR1 to OR6. The outputs of the aforementioned comparators C11 to C16 are supplied to the other inputs of the aforementioned OR circuits OR1 to OR6.

On the other hand, the second detecting circuit 16b is structured from AND/OR circuits AOR1 to AOR6, AND circuits A1 to A4, latch circuits XA, YA, ZA, ZZA, YM, ZM, ZW, L0Miss1X, L0Miss1Y, L0Miss1Z, and an OR circuit OR7. The AND/OR circuits AOR1 thorough AOR6 are connected to AND circuits and OR circuits in series. The AND/OR circuits AOR1 to AOR6 detect an instruction depending on the load instruction indirectly, and map the detected dependency to a direct dependency.

An output signal EqA of the aforementioned OR circuit OR1 is supplied to one input end of the AND circuits structuring the AND/OR circuits AOR1, AOR2 and AOR3. An output signal EqM of the aforementioned OR circuit OR2 is supplied to one input of the AND circuits structuring the AND/OR circuits AOR4, AOR5. An output signal EqW of the aforementioned OR circuit OR3 is supplied to one input of the AND circuit structuring the AND/OR circuit AOR6, and to one input of the AND circuit A1. An output signal EqX of the aforementioned OR circuit OR4 is supplied to one input of the AND circuit A2. An output signal EqY of the aforementioned OR circuit OR5 is supplied to one input of the AND circuit A3. An output signal EqZ of the aforementioned OR circuit OR6 is supplied to one input of the AND circuit A4.

On the other hand, the cache miss signal L0Miss1W supplied from the load store unit 18b is supplied to the other input of the aforementioned AND circuit A1, and is supplied to the latch circuit L0Miss1X. The output signal of the latch circuit L0Miss1X is supplied to the other input of the aforementioned AND circuit A2, and is supplied to the latch circuit L0Miss1Y. The output signal of the latch circuit L0Miss1Y is supplied to the other input of the aforementioned AND circuit A3, and is supplied to the latch circuit L0Miss1Z. The output signal of the latch circuit L0Miss1Z is supplied to the other input of the aforementioned AND circuit A4.

The output signals DDZ, DDY and DDX of the aforementioned AND circuits A4, A3 and A2 are respectively supplied to one input of the OR circuits structuring the aforementioned AND/OR circuits AOR6, AOR5 and AOR3. The output signal of the OR circuit structuring the aforementioned AND/OR circuit AOR6 is supplied to one input of the OR circuit structuring the aforementioned AND/OR circuit AOR4. The output signal of the OR circuit structuring the aforementioned AND/OR circuit AOR4 is supplied to one input of the OR circuit structuring the aforementioned AND/OR circuit AOR1. The output signal of the OR circuit structuring the aforementioned AND/OR circuit AOR5 is supplied to one input of the OR circuit structuring the aforementioned AND/OR circuit AOR2.

An output signal DDW of the aforementioned AND circuit A1 is supplied to the latch circuit XA.

Output signals of the OR circuits structuring the aforementioned AND/OR circuits AOR1, AOR2 and AOR3 are supplied to the inputs of the aforementioned latch circuits ZZA, ZA and YA. Output signals of these latch circuits XA, YA, ZA and ZZA are supplied to the input of the OR circuit OR7. Further, the output signals of these latch circuits XA, YA and ZA are respectively supplied to the other inputs of the AND circuits structuring the aforementioned AND/OR circuits AOR3, AOR2 and AOR1.

An output signal of the aforementioned latch circuit XA is supplied to the latch circuit YM, and an output signal of the aforementioned latch circuit YA is supplied to the latch circuit ZM. An output signal of the aforementioned latch circuit YM is supplied to the latch circuit ZW. Output signals of the aforementioned latch circuits ZM, YM are respectively supplied to the other inputs of the AND circuits structuring the aforementioned AND/OR circuits AOR4, AOR5. An output signal of the latch circuit ZW is supplied to the other input of the AND circuit structuring the aforementioned AND/OR circuit AOR 6. A signal Depend1A showing the presence/absence of dependency which will be described later is outputted from the output of the aforementioned OR circuit OR7.

The DLC 16 having the above-described structure detects a dependency in accordance with the following steps.

(1) Comparing physical register numbers.

(2) Detecting direct dependency.

(3) Detecting indirect dependency, and mapping the detected indirect dependency to direct dependency.

(4) Generating a dependent signal.

(5) Staging direct dependency.

Operation of the above-described DLC 16 will be described with reference to FIG. 11C. In FIG. 11C, it is supposed that the lw (load) instruction of (1) generates a cache miss.

The destination register numbers of the respective instructions and the numbers of the source registers Rs, Rt are outputted from the instruction window buffer 14a in accordance with the order shown by (1) to (6) in FIG. 11C. The destination register numbers are supplied to the register R1 of the DLC 16. The destination register numbers held in the register R1 are successively shifted to the registers R1 to R6 in accordance with the execution of the respective stages of the pipeline. Further, the numbers of the source register Rt of the respective instructions are simultaneously supplied to the comparators C1 to C6, and the numbers of the source register Rs are simultaneously supplied to the comparators C11 to C16.

There is an add instruction of (3) in the D stage at time t4. Therefore, it is searched whether the numbers of the two source registers Rs, Rt of the add instruction coincide with the destination register numbers of the load instruction in a state of execution (in-flight). Simultaneously, it is searched whether the numbers of the two source registers Rs, Rt of the add instruction coincide with the destination register numbers of another instruction depending on the load instruction in a state of execution. Concretely, the numbers of the source registers Rs, Rt and the destination register numbers Rd of the respective stages of A, M, W, X, Y and Z are compared by comparators C1 to C6 and C11 to C16.

Namely, at the time t4, both the number of the source register Rs of the D stage and the number of the destination register Rd held in the register R3 corresponding to the W stage of the lw instruction of (1) are register number “rl”. Therefore, a coinciding signal is outputted from the comparator C13, and the output signal EqW of the OR circuit OR3 becomes “1”. Because a coinciding signal is not outputted from the comparators other than the comparator C13, the output signals of the OR circuits other than the OR circuit OR3 become “0”.

On the other hand, it is known if a cache miss occurs at the W stage of the lw instruction of (1). Therefore, at the time t4, the cache miss signal L0Miss1W is “1”, and this cache miss signal L0Miss1W and the output EqW of the OR circuit OR3 are supplied to the AND circuit A1. Therefore, the output signal DDW of the AND circuit A1 is “1”. The signal DDW is a signal showing whether or not an instruction of the D stage depends directly on the load instruction of the W stage. Moreover, when the signal DDW is “1”, it shows that the instruction of the D stage depends directly on the load instruction of the W stage, and that a cache miss has arisen.

Further, the latch circuit L0Miss1X holds a signal in which the aforementioned cache miss signal L0Miss1W is delayed by one cycle. Therefore, the latch circuit L0Miss1X is “1” when the load instruction of the X stage cache-misses. In the same way, the latch circuits L0MissY, L0MissZ are “1” when the load instructions of the Y stage, the Z stage cache-miss. The output signals of the latch circuits L0Miss1X, L0MissY and L0MissZ are, together with the output signals EqX, EqY and EqZ of the OR circuits OR4, OR5 and OR6, respectively supplied to the AND circuits A2, A3 and A4. Therefore, when the output signals DDX, DDY and DDZ of the AND circuits A2, A3 and A4 are “1”, the instruction of the D stage directly depends on the load instructions of the X stage, Y stage, and Z stage, and a cache miss has arisen.

Next, at a time t5, because the signal DDW was “1” at the former cycle, the latch circuit XA becomes “1”. The signal of the latch circuit XA delays the signal DDW by one cycle. Therefore, the signal of the latch circuit XA means that the instruction of the A stage depends on the load instruction of the X stage. The output signal Depend1A of the OR circuit OR7 becomes “1” in accordance with the output signal of the latch circuit XA. The signal Depend1A is the OR of the latch circuits XA, YA, ZA and ZZA. Therefore, the signal Depend1A shows that the instruction of the A stage depends on the load instructions of one of the X stage, Y stage, Z stage and ZZ stage of the pipeline, and the that load instruction cache-misses. The latch circuits XA, YA, ZA and ZZA hold signals containing information of the cache miss. Accordingly, the output signals of the latch circuits XA, YA, ZA and ZZA are signals in which the cache miss is verified.

Further, the lw (load) instruction of (2) and the sub-instruction of (4) shown in FIG. 11C have dependency. Because it is supposed that the lw instruction of (2) cache-hits, the output signal DDW of the AND circuit A1 becomes “0”.

Next, at a time t6, an xor instruction of (5) shown in FIG. 11C is at the D stage. Therefore, the presence/absence of the load instruction on which the xor instruction depends is searched. Namely, the numbers “r4”, “r7” of the source registers Rs, Rt of the xor instruction in the D stage, and the numbers of the destination registers held by the registers R1 to R6 of the respective stages, are compared. In this case, the number of the destination register of the M stage is the register number “r4” used for the add instruction of (3). Moreover, the destination register number of the sub-instruction of (4) held by the latch circuit R1 of the A stage is “r7”. Therefore, the output signals of the comparators C12, C1 are “1”. Accordingly, the output signal EqM of the OR circuit OR2 becomes “1”, and the output signal EqA of the OR circuit OR1 becomes “1”.

Further, at the time t6, the output signal “1” of the aforementioned register XA is set to the register YM. Therefore, the output signal of the register YM becomes “1”. The output signal of the register YM is, together with the output signal EqM of the OR circuit OR2, supplied to the AND/OR circuit AOR5. Therefore, the signal “1” is outputted from the AND/OR circuit AOR5. This signal is supplied via the AND/OR circuit AOR2 to the latch circuit ZA as a signal YD.

Moreover, the output signal of the aforementioned OR circuit OR1 is supplied to the one input ends of the AND circuits structuring the AND/OR circuits AOR1, AOR2 and AOR3. However, all of the output signals of the latch circuits XA, YA, ZA and ZZA are “0”. Therefore, the input conditions of the respective AND circuits structuring the AND/OR circuits AOR1, AOR2 and AOR3 are not established. Therefore, a dependency with the sub-instruction of (4) at the A stage is not held. This is because the lw instruction, with which the sub-instruction of (4) has dependency, cache-hits, and therefore, at the time t6, the output signal of the latch circuit XA becomes “0”. In this way, instructions which directly and indirectly depend on a load instruction in which a cache miss arises can be detected.

Namely, the second detecting circuit 16b detects the dependency between the dependency of all of the instructions in the execution state and all of the load instructions having a cache miss in the A to Z stages. In other words, the second detecting circuit 16b detects indirect dependencies of plural stages, and changes them into direct dependencies, and detects therefrom only the dependencies in the case of a cache miss. What stages do all of the instructions depending on the load instruction which cache-missed exist in, can be directly detected without using a complex list.

In the above description, it is supposed that a cache miss of the load instruction becomes known in the W stage. However, a case in which a cache miss of the load instruction becomes clear in the X stage or the Y stage can be supposed. In such a case, because the speculative execution period is long, the number of speculative instructions increases, and the number of stages of indirect dependency increases. However, by using the DLC 16 having the above-described structure, it is possible to detect direct and indirect dependencies by a minimum hardware structure.

As described above, when an instruction depending on the load instruction at which a cache miss arises is detected by the DLC 16, the signal Depend1A showing the presence/absence of dependency is outputted from the OR circuit OR7 structuring the second detecting circuit 16b. This signal Depend1A is supplied to the register score board unit 15a and the RAT 22 shown in FIG. 5.

The contents of the register score board unit 15a and the RAT 22 are updated in accordance with the signal Depend1A.

(Updating of the RAT by Cache Miss)

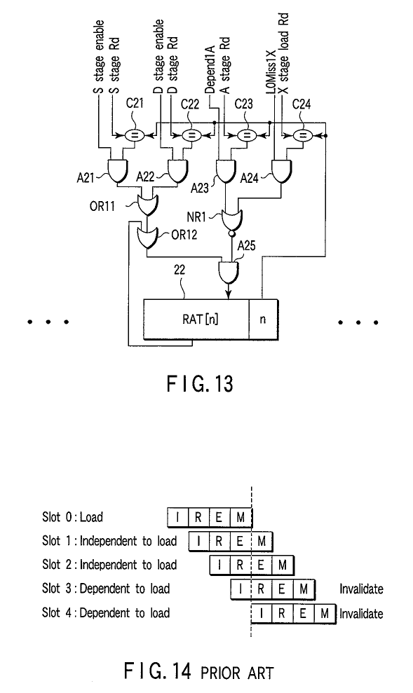

FIG. 13 shows an example of an update circuit 22a of the RAT 22. This update circuit 22a is structured from, for example, a plurality of AND circuits A21 to A25, a plurality of comparators C21 to C24, OR circuits OR11, OR12, and a NOR circuit NR1.

Usually, at the final S stage of the ALU instruction, or at the D stage of the load instruction, an entry of the RAT corresponding to the destination register Rd which the instruction writes is set. This considers the issue delay of the instruction referring to the physical register.

In FIG. 13, in the case of the ALU instruction, the number of the destination register (physical register) Rd in the final S stage and the entry number (n) of the RAT 22 are compared by the comparator C21. Further, in the case of a load instruction, the number of the destination register Rd in the D stage and the entry number of the RAT 22 are compared by the comparator C22. When the number of the destination register Rd and entry number of the RAT 22 coincide and a valid instruction exists in the stage, the RAT 22 is set.

Note that, FIG. 13 is a working RAT, and does not contain a restore from an in-order RAT for restoring a branch predicting miss, or a path clearing the RAT when a physical register is released.

On the other hand, in a case where a cache miss arises in the load instruction, when there is, in the A stage, an instruction depending on the load instruction, the number of the destination register Rd and the entry number of the RAT 22 are compared by the comparator C23. As a result of this comparison, when these coincide and the signal Depend1A supplied from the DLC 16 is “1”, a flag of the RAT 22 for the destination register writing the result of the instruction depending on the load instruction is cleared. As described above, the signal Depend1A being “1” means that an instruction in the A stage has dependency on the load instruction, and the load instruction cache-missed. Namely, the instruction in the A stage can no longer obtain the correct source operand. Accordingly, because the result of execution of this instruction is not correct, the flag of the destination register of that instruction of the RAT 22 is cleared.

Further, the destination register Rd, to which the result of execution of the load instruction which cache-missed is supplied, is also cleared. Namely, when a cache miss arises in the load instruction, the destination register Rd of the load instruction in the X stage and the entry number of the RAT 22 are compared by the comparator C24. As a result of this comparison, when both coincide and the cache miss signal L0Miss1X is “1”, the flag of the destination register Rd, to which the result of execution of the load instruction of the RAT 22 which missed cache is supplied, is cleared.

In this way, all of the flags, which are the destination register Rd of the load instruction having a cache miss and the destination register Rd of the instruction depending thereon, and which are set to the entry of the register to which the RAT 22 already corresponds, are cleared.

Further, by clearing the flag of the RAT 22, at the time from the X stage on of the load instruction at which the cache miss became known, the Rd, including the multiple indirect dependency, cannot be referenced. Further, the update circuit 21 shown in FIG. 5 clears the RsRdy, RtRdy, and RfRdy of the instruction window buffer 14a on the basis of the contents of the RAT 22. Thus, instructions dependent on the load instruction at which the cache miss occurred can no longer be issued.

By executing the above-described operations at each cycle, the registers depending directly and indirectly on the load instruction causing the cache miss are invalidated, and the instructions dependent on the load instruction at which the cache miss occurred are invalidated.

(Rollback Operation at IWB)

When a load instruction generates a cache miss, the load instruction having the cache miss and all of the instructions dependent thereon are reissued. This operation is called rollback. Here, the rollback method will be described.

After an instruction is issued from the instruction window buffer 14a, the load instruction, or the store instruction, currently being executed at which no cache miss has become clear, and all of the instructions thereafter remain held in the instruction window buffer 14a. At this time, the In-Flight bit of the instruction window buffer 14a is set. When the cache hits, at the X stage, the load instruction, or the store instruction, clears the Valid bit of the instruction window buffer 14a, and deletes it from the instruction window buffer. When a cache miss is generated, the InFlight bit is cleared, and the Valid bit remains set. Simultaneously, the L1MissSM bit is changed to the cache miss state. When refilling of the cache is completed, the L1MissSM bit is reset to the initial state. Thereafter, the load instruction, or the store instruction, is again scheduled and issued.

On the other hand, with regard to instructions depending on the load instruction and instructions indirectly depending on the load instruction, when the instruction reaches the A stage, if the signal Depend1A is “1”, the load instruction, which is the source of dependency including indirect dependencies, cache-misses. Thus, this instruction remains without being deleted from the instruction window buffer. Further, when the signal Depend1A is “0”, the dependent load instruction hits, and thus, this instruction is cleared from the instruction window buffer.

In accordance with the above-described embodiment, the DLC 16 has the first detecting circuit 16a detecting an instruction directly dependent on the load instruction, and a second detecting circuit 16b detecting an instruction indirectly dependent on the load instruction. The second detecting circuit 16b detects plural-stage indirect dependencies between all of the instructions in the execution state and all of the load instructions in the A to Z stages. The second detecting circuit 16b detects, thereamong, indirect dependency only when a cache miss is generated. Thus, the DLC 16 can detect at high speed instructions depending directly and indirectly on a load instruction at which a cache miss is generated.

Moreover, the DLC 16 can directly detect in which stages all of the instructions dependent on the load instruction having the cache miss exist, without using a complex list and without tracing all of the data flow graphs. Accordingly, there is the advantage that an increase in the scale of the circuit can be prevented.

Further, the DLC 16 invalidates only instructions depending directly and indirectly on a load instruction having a cache miss. Thus, as compared with a case in which all of the instructions from the load instruction, having the cache miss, and instructions thereafter are invalidated, needless invalidation of instructions can be prevented. Accordingly, because the number of instructions to be reissued can be reduced, the instruction issuing efficiency can be improved.

Moreover, on the basis of the output signal from the DLC 16, the contents of the register score board 15a and the RAT 22 are changed each cycle. Thus, the registers and instructions depending on a load instruction detected by the DLC 16 can be cancelled efficiently. Further, the contents of the instruction window buffer 14a are updated each cycle in accordance with the contents of the register score board 15a and the RAT 22. Thus, after the cache has been refilled, the cancelled instruction can be reissued reliably.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An instruction issuing device comprising:
an instruction issuing section which speculatively issues instructions out-of-order;
a first detecting circuit which detects direct dependencies between the instructions issued from the instruction issuing section and a plurality of instructions including a load instruction in each stage of a pipeline; and
a second detecting circuit to which output signals of the first detecting circuit and cache miss signals of the load instruction are supplied, the second detecting circuit detecting indirect dependencies between the instructions issued from the instruction issuing section and the load instruction which cache-missed in each stage of the pipeline, on the basis of the output signals of the first detecting circuit and the cache miss signals of the load instruction.

2. The device according to claim 1, wherein the first detecting circuit comprises:
a plurality of first registers connected in series, and provided in the same number as pipeline stages, each of the first registers holding a destination register number to which an execution result of the instruction is written; and
a plurality of first comparators which compare the destination register number held in each of the first registers with first source register numbers of instructions following the load instruction, signals output from the first comparators showing whether the other instructions have direct dependencies on the load instruction.

3. The device according to claim 2, wherein the first detecting circuit further comprises:
a plurality of second comparators which compare the destination register number held in each of the first registers with second source register numbers of instructions following the load instruction, signals output from the second comparators showing whether the other instructions have direct dependencies on the load instruction; and
a plurality of OR circuits to which the signals output from the first and second comparators are supplied, respectively.

4. The device according to claim 3, wherein the second detecting circuit comprises:
a plurality of first latch circuits which hold dependencies on the load instruction at each pipeline stage, the first latch circuit including a first latch circuit group and a second latch circuit group;
a plurality of second latch circuits connected in series, each of the second latch circuits holding the cache miss signal in synchronization with operation of the pipeline;
a plurality of first logic circuits to which output signals of the second latch circuits and output signals of a first OR circuit group among the OR circuits are supplied, each of the first logic circuits generating a signal which depends directly on the load instruction and includes the cache miss signal in accordance with signals output from the second latch circuit and signals output from the first OR circuit group; and
a second logic circuit which detects instructions depending indirectly on the load instruction in accordance with output signals of a second OR circuit group among the OR circuits, signals output from the first and second latch circuit groups, and output signals output from the first logic circuit, signals output from the second logic circuit being supplied to the first latch circuit group.

5. The device according to claim 4, wherein the instruction issuing section invalidates instructions depending on the load instruction, in accordance with the output signals the second detecting circuit.

6. The device according to claim 5, wherein the instruction issuing section reissues invalidated instruction after a cache is refilled.

7. An instruction issuing device comprising:
an instruction issuing section which speculatively issues instructions out-of-order;
a first detecting circuit which detects direct dependencies between the instructions issued from the instruction issuing section and a plurality of instructions including a load instruction in each stage of a pipeline;
a second detecting circuit to which output signals of the first detecting circuit and cache miss signals of the load instruction are supplied, the second detecting circuit detecting indirect dependencies between the instructions issued from the instruction issuing section and the load instruction which cache-missed in each stage of the pipeline, on the basis of the output signals of the first detecting circuit and the cache miss signals of the load instruction;
a first storing section which is connected to the second detecting circuit and stores first information, the first information showing whether data held in a writing register of an instruction being executed in the pipeline is valid;
a second storing section connected to the first detecting circuit and the second detecting circuit and configured to store section storing information showing whether a register can be used, in accordance an the output signal of the first storing section; and
an update circuit which updates information showing validity of a source operand of the instruction issuing section in accordance with the output signals of the first and second storing sections.

8. The device according to claim 7, wherein the first detecting circuit comprises:
a plurality of first registers connected in series and provided in the same number as pipeline stages, and each of the first registers holding a destination register number to which an execution result of the instruction is written; and
a plurality of first comparators which compare the destination register number held in each of the respective first registers with first source register numbers of instructions following the load instruction, signals output from the first comparator showing whether the other instructions have direct dependencies on the load instruction.

9. The device according to claim 8, wherein the first detecting circuit further comprises:
a plurality of second comparators which compare the destination register number held in each of the first registers with second source register numbers of instructions following the load instruction, signals output from the second comparator showing whether the other instructions have direct dependencies on the load instruction; and
a plurality of OR circuits to which the signals output from the first and second comparators are supplied, respectively.

10. The device according to claim 9, wherein the second detecting circuit comprises:
a plurality of first latch circuits which hold dependency on the load instruction at each pipeline stage, the first latch circuit including a first latch circuit group and a second latch circuit group;
a plurality of second latch circuits connected in series, each of the second latch circuits holding the cache miss signal in synchronization with operation of the pipeline;
a plurality of first logic circuits to which signals output from the second latch circuit and signals output from a first OR circuit group among the OR circuits are supplied, each of the first logic circuits generating a signal which depends directly on the load instruction and includes the cache miss signal in accordance with the output signals of the second latch circuit and the output signals of the first OR circuit group; and
a second logic circuit which detects instructions depending indirectly on the load instruction in accordance with the signals output from the second OR circuit group among the OR circuits, the signals output from the first and second latch circuit groups, and the signals output from the first logic circuit, the signals output from the second logic circuit being supplied to the first latch circuit group.

11. The device according to claim 10, wherein the instruction issuing section invalidates instructions depending on the load instruction, in accordance with the output signals of the second detecting circuit.

12. The device according to claim 11, wherein the instruction issuing section reissues the invalidated instructions after a cache is refilled.

13. The device according to claim 7, wherein the second storing section has a third logic circuit which clears a flag corresponding to a register, depending on the load instruction which cache-missed, in accordance with the output signal of the second detecting circuit.

14. An instruction issuing method comprising:
detecting direct dependencies of a load instruction and following instructions in a first detecting circuit;
detecting indirect dependencies of the load instruction and following instructions in a second detecting circuit, and converting the detected indirect dependencies to direct dependencies; and
detecting instructions having indirect dependencies on the load instruction by a signal showing that a cache miss has arisen in the load instruction and the converted direct dependencies.

15. The method according to claim 14, further comprising:
invalidating instructions having direct dependencies on the detected load instruction, and instructions having indirect dependencies on the detected load instruction.

16. The method according to claim 15, further comprising:
reissuing the invalidated instruction when a cache is refilled.
